(19) United States
(12) Patent Application Publication
(10) Pub. No.: US 2004/0250458 A1
(43) Pub. Date: Dec. 16, 2004

(54) Multipurpose hanging picture

(76) Inventor: Yong Cheol Kim, Seoul (KR)

Correspondence Address: ST. ONGE STEWARD JOHNSTON & REENS, LLC, 986 BEDFORD STREET, STAMFORD, CT, 06905-5619, US

(21) Appl. No.: 10/865,306

(22) Filed: Jun. 10, 2004

(30) Foreign Application Priority Data
Jun. 12, 2003 (KR) 2003-18419

(51) Int. Cl. G09F 7/22

(52) U.S. Cl. 40/617

(57) ABSTRACT

Disclosed is a multipurpose hanging picture, wherein in case that generally used hanging pictures are connected in plurality, they can be connected and separated easily. For this, the multipurpose hanging picture comprising: a printed hanging sheet on which pictures, paintings, targets or dart games are printed; a hanging rod detachably coupled to one side or both sides of the printed hanging sheet; an advertisement unit mounted to the hanging rod and functioning as an advertisement; a hanging cap mounted to both ends of the hanging rod and supporting it; and a hanging wire coupled to the hanging caps and stopped by it. And said hanging rod comprises at lease one locking slit provided on an outer surface of the hanging rod, a reinforcing rib formed inside the hanging rod to support it, and at least one locking groove provided concavely on the outer surface of the hanging rod so that the advertisement unit can be detachably attached.

This application claims priority of pending Korean Patent Application No. 2003-18419 filed Jun. 12, 2003.

### BACKGROUND OF THE INVENTION

1. Field of the Invention

The present invention relates, in general, to a multipurpose hanging picture, in particular, to a multipurpose hanging picture, in which a plurality of pictures, paintings or calendars etc., (hereinafter, refer as “hanging picture”) are connected and can be used as hanging picture in various shapes.

2. Description of the Related Art

Conventional hanging device is generally structured to hang hanging picture or decoration etc., but this hanging device mostly has just one function, therefore there is a problem that both a soft material (in example, non-woven fabric) and a hard material (in example, plastic sheet, PP sheet) can not be used together for the hanging device.

For solving this problem, the same applicant filed a utility model (application date: Mar. 11, 1997, Korean utility model application no. 20-1997-004449, title: multipurpose hanging picture) before the Korean intellectual property office. However, the above multipurpose hanging picture has an advantage of using with conventional various materials, but it has a problem that a plurality of hanging pictures can not be consecutively coupled and in particular, it can not function as both a dart plate and an advertisement in addition to the hanging picture.

### SUMMARY OF THE INVENTION

Accordingly, the present invention relates to a multipurpose hanging picture to solve the above problem, and it is an object of the present invention to provide a multipurpose hanging picture, in which a plurality of hanging pictures are consecutively connected in a vertical or horizontal direction and various games or pictures etc. may be provided to user.

And it is another object of the present invention to provide a multipurpose hanging picture which user can carry easily and enjoy a dart game everywhere since a plurality of hanging pictures on which dart plates for dart games are printed may be kept easily by rolling up.

And it is another object of the present invention to provide a multipurpose hanging picture, in which one side or both sides of a hanging rod connecting the hanging picture or dart plate has an advertisement function, and accordingly its sales can be promoted.

And it is another object of the present invention to provide a multipurpose hanging picture, in which a pocket for keeping article is formed at a lower end of the hanging picture and the convenience of use is improved.

Based on the present invention, the above objects can be accomplished by a provision of a multipurpose hanging picture, which comprises a printed hanging sheet on which pictures, paintings, targets or dart games etc. are printed, a hanging rod detachably coupled to one side or both sides of the printed hanging sheet, an advertisement unit mounted to the hanging rod and functioning as an advertisement, a hanging cap mounted to both ends of the hanging rod and supporting it, and a hanging wire coupled to the hanging caps and stopped by it.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view illustrating a using state of multipurpose hanging picture in accordance with an embodiment of the present invention;

FIG. 2 is a disassembled perspective view of a main portion of the present invention;

FIG. 3 is a cross-sectional view taken along the line A-A of FIG. 1;

FIGS. 4(a) and 4(b) are other embodiments of a hanging rod of the present invention;

FIG. 5 is a perspective view of other embodiment of a printed hanging sheet of the present invention;

FIG. 6 is other embodiment of a locking projection of the present invention;

FIG. 7 is a perspective view illustrating a using state in accordance with second embodiment of the present invention;

FIG. 8 is a perspective view of a printed hanging sheet of the present invention used in FIG. 7.

FIG. 9 is a partial cross-sectional view in accordance with third embodiment of the present invention;

FIG. 10 is a disassembled perspective view of a main portion of the FIG. 9;

FIG. 11 is a perspective view illustrating a using state in accordance with third embodiment of the present invention;

FIG. 12 is a cross-sectional view of a coupling piece of the present invention;

FIG. 13 is a perspective view of an intermediate coupling piece of the present invention;

FIG. 14 is a perspective view illustrating a state wherein a plurality of printed hanging sheets of the present inventions is coupled in a horizontal direction.

FIG. 15 a perspective view illustrating a state wherein a plurality of pictures is formed on the printed hanging sheet of the present invention.

### DETAILED DESCRIPTION OF PREFERRED EMBODIMENT

The specific constitution in regard to the present invention is described as follows via the accompanying drawings.

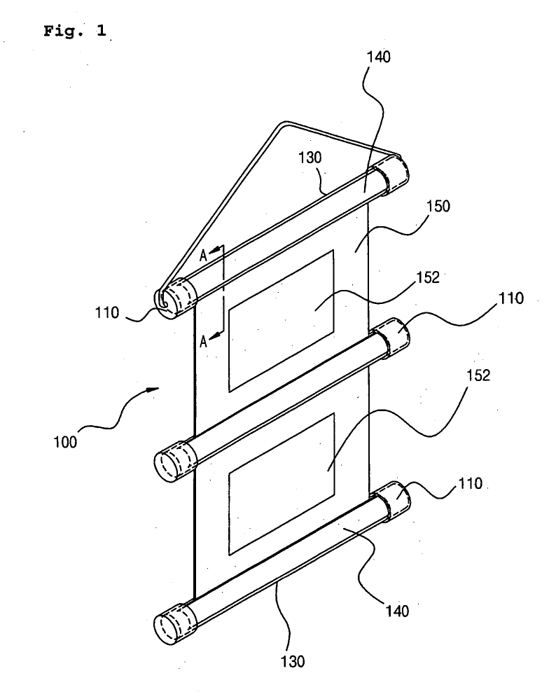

FIG. 1 is an outer perspective view of a multipurpose hanging picture 100 of the present invention, and the multipurpose hanging picture 100 comprises a printed hanging sheet 150 on which pictures, paintings or dart games etc. are printed, a hanging rod 130 detachably coupled to an upper and lower side of the printed hanging sheet 150, an advertisement unit 140 mounted to the hanging rod 130 and functioning as an advertisement, and a hanging cap 110 mounted to both ends of the hanging rod 130 and supporting it.

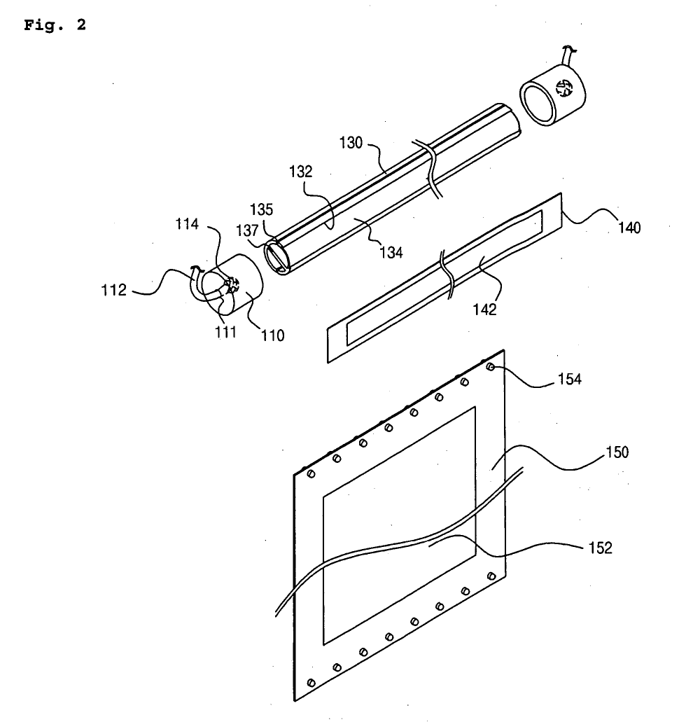

The hanging cap 110, as shown in FIG. 2, comprises a hole 111 formed on an outer surface of it and a hanging wire 112 inserted to the hole 111 and stopped by a stop end 114 not to be separated from the hole 111.

In the stop end 114, the end of the hanging wire 112 is knotted several times to provide a stop function, otherwise, other article is knotted inside the hanging cap 110 so that the hanging wire 112 can not pass through the hole 111.

If user wish to keep by winding the printed hanging sheet 150 or move after using it, the user can wind the printed hanging sheet 150 and tie it with a string, or if necessary, the user can separate a plurality of hanging cap 110 mounted to both ends of the hanging rod 130 and then tie the printed hanging sheet 150 with the hanging wire 112 connected with the hanging cap 110.

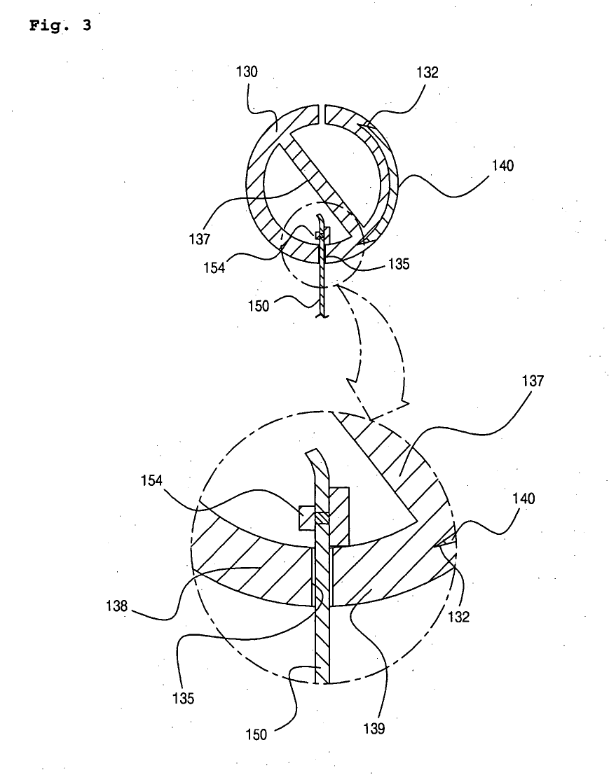

As shown in FIGS. 2 and 3, the hanging rod 130 comprises at least one locking slit 135 provided on an outer surface of the hanging rod 130, at least one reinforcing rib 137 formed to support the hanging rod 130, and a locking groove 132 provided concavely on the outer surface of the hanging rod 130 so that the advertisement unit 140 can be detachably attached.

Accordingly, the locking groove 132 is formed slopingly along the outer surface of the hanging rod so that the advertisement unit 140 can be inserted to it without being separated, and the advertisement unit 140 is mounted to the locking groove 132 by being inserted from one end of the hanging rod 130 and moving to the other end of it.

In addition, the locking groove 132 may be provided as a plurality on both sides of the hanging rod 130 or may be provided over almost entire outer surface of it.

The cutting width of the locking slit 135 is determined by used material and in case that the printed hanging sheet 150 is inserted to the locking slit 135 from one end of it, the printed hanging sheet 150 is inserted while being in contact with both edges of the locking slit 135, and in case that the material of the printed hanging sheet 150 is thin, the cutting width of the locking slit 135 is formed narrowly, whereas in case that the material of the printed hanging sheet 150 is thick, the cutting width of the locking slit 135 is formed widely.

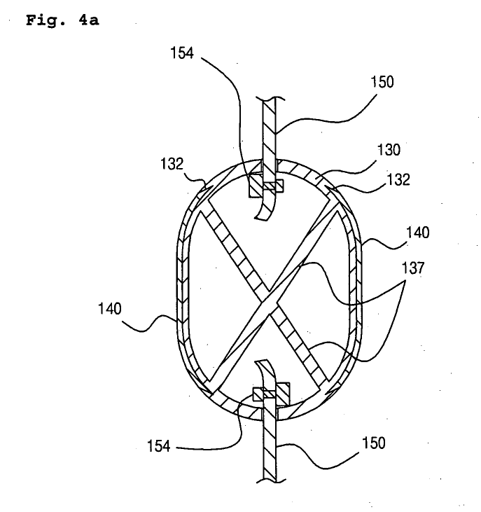

And the locking slit 135, as shown in FIGS. 4(a) and 4(b), can be formed on both sides or one side of the hanging rod 130 according to the using state, and in case that it is formed on both sides, as shown in FIG. 1, a plurality of printed hanging sheet 150 can be consecutively coupled to each other.

Furthermore, the reinforcing rib 137, as shown in FIG. 3, may be slopingly formed as a single inside the hanging rod 130, or if necessary, it may be formed as a plurality as shown in FIG. 4(a).

In addition, the reinforcing support part 139 of one end of the locking slit 135 is spaced from the first end of the reinforcing rib 137 by a shorter distance so that the locking projection 154 mounted to an upper end of the printed hanging sheet 150 and provide a stop function can not be separated outwardly, i.e., even though user pulls the printed hanging sheet 150 down, the locking slit 135 can resist the pulling power, whereas, because a sub-support part 138 is spaced from the second end of the reinforcing rib 137 by a longer distance and can not resist a big load, it supports the locking slit 135 secondarily.

Accordingly, the locking projection 154 has to be assembled in a direction of the reinforcing support part 139.

And the outer structure of the hanging rod 130, as described above, is not limited to a round shape or an elliptical shape and it can be formed variously in the shape of a polygon or heart.

And the advertisement unit 140 is mounted to the locking groove 132 and has advertising effect, and has an advertisement part 142 printed by the printing method of generally used silk printing, offset printing and UV coating etc., and the printing can be formed inside or outside the advertisement unit 140.

In addition, besides the printing for advertisement, the advertisement unit 140 may further has a thermometer formed thinly in the shape of a plane and used in the office or home, and because the thermometer may be a plane and bent flexibly, it is inserted and mounted to the locking groove 132 by bending and sliding to correspond to the rounded shape of the locking groove 132.

Furthermore, the printed hanging sheet 150 is made of paper, textile, leather, plastic, iron plate or iron-rubber sheet or may be formed by integrating them into a single body, and comprises a plurality of locking projections 154 projected outwardly at the upper and lower end of the printed hanging sheet 150 so that it can not be separated from the locking slit 135 and support it when the printed hanging sheet 150 is inserted to the locking slit 135, and a printed part 152, in which the picture is formed on one surface or both surfaces.

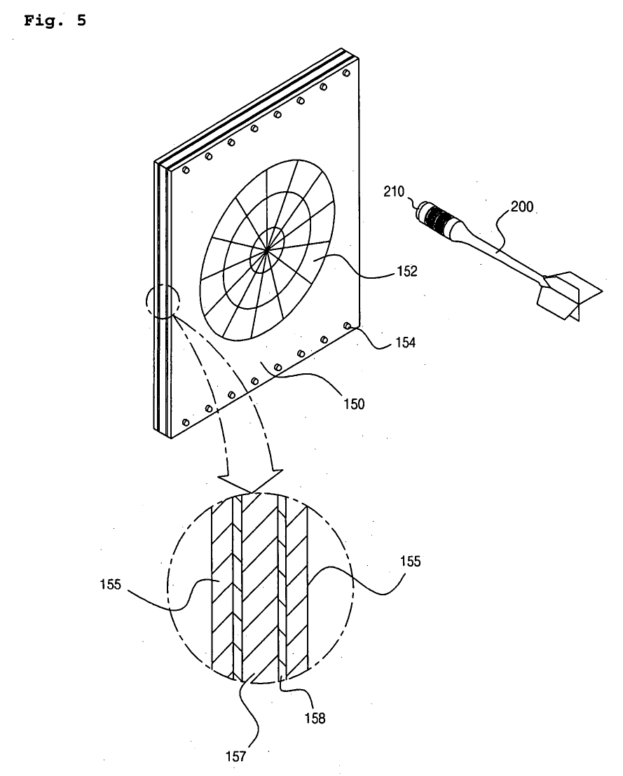

The locking projection 154 can be made of metal in the shape like FIG. 6 according to the using state, in this case, because user can put a plurality of locking projections 154 in a certain distance from the upper and lower end of the printed hanging sheet 150 without using a machine and use them, it is easy to maintain a horizon of the printed hanging sheet 150, and because user can work by using the locking projection 154, two, three or more printed hanging sheets 150 may be coupled together and used.

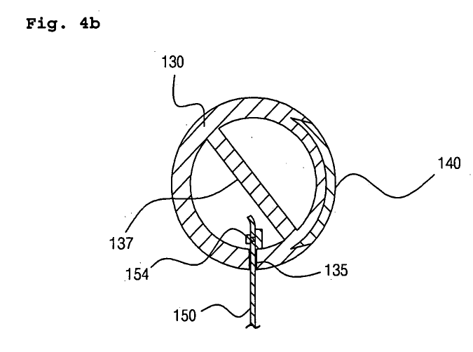

As shown in FIG. 5, other embodiment of the present invention is different that it has the printed hanging sheet 150 on which a target for a dart game is printed, the other structure and operation of it is same with the embodiment described above. Accordingly, the printed hanging sheet 150 of the other embodiment is made of paper, textile, leather, plastic, iron plate or iron-rubber sheet etc. or the combination of them.

Especially, the printed hanging sheet 150 for a dart game desirably comprises a iron-rubber plate 157 made of iron-rubber sheet so that a magnet 210 formed at the end of a magnetic dart 200 can be attached to it, an outer sheet 155 formed outside the iron-rubber plate 157 and on which the printed part for a dart game 152 is formed, and an adhesive 158 spread between the iron-rubber plate 157 and the outer sheet 155 and bonding them together not to be separated from each other.

The iron-rubber plate 157 is made of a iron plate or a iron-rubber sheet of flexible material.

And in case that the outer sheet 155 is formed on front and rear surface of the printed hanging sheet 150, different pictures can be printed on both surfaces of it, in example, the picture for a dart game is printed on one surface and the picture for other game is printed on the other surface.

As shown in FIG. 5, the outer sheet 155 of the printed hanging sheet 150 may be made of paper, plastic, textile or leather etc. and the iron-rubber plate 157 formed in the middle is made of the iron plate or the iron-rubber sheet so that the magnet 210 of the magnetic dart 200 can be attached to it.

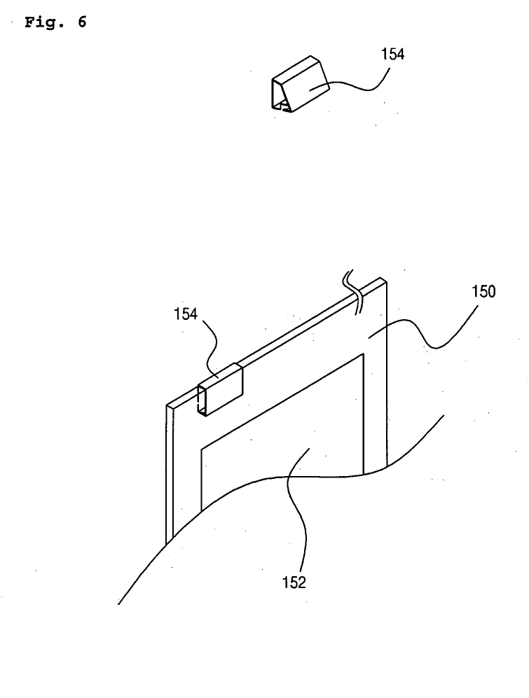

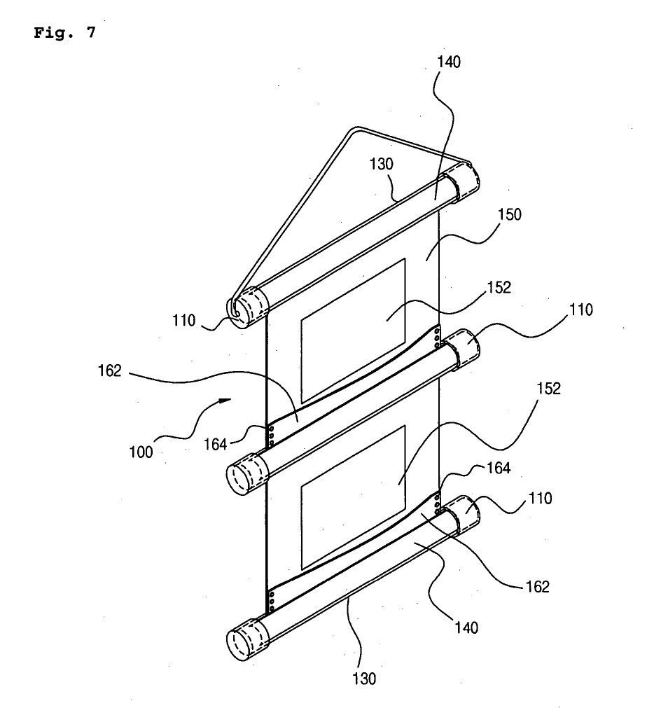

And FIGS. 7 and 8 are second embodiment of the present invention, and its difference with the embodiments described above is that a pocket 162 for keeping articles is additionally formed on the lower end of the printed hanging sheet 150, and the pocket 162 is formed by use of the snap fasteners 164 so that it can be detachably attached to the printed hanging sheet 150 according to user's preference.

The pocket 162 is manufactured in the factory or is selected and made by user according to user's preference. In case that it is made by user, the snap fasteners 164 detachably attached is used for making the pocket 162.

And the snap fasteners 164 may be generally used snap and it may be just formed on both sides of the pocket 162 or formed on the upper and lower end of the printed hanging sheet 150.

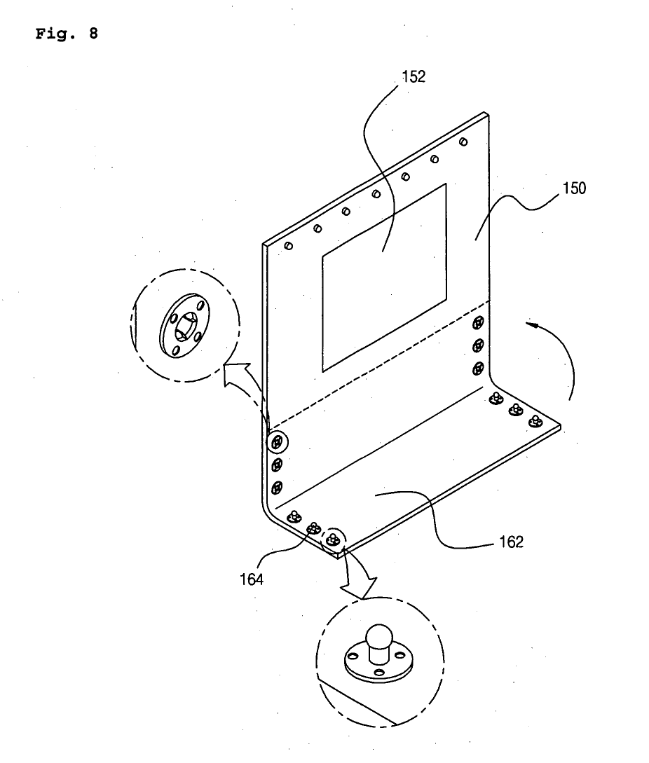

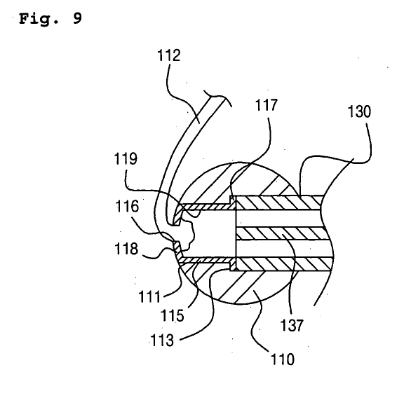

FIGS. 9 and 10 are cross-sectional view and disassembled perspective view of main portion of third embodiment of the present invention, its difference with the embodiments described above is that a sub-cap 115 is inserted to a step 113 stepped inside the hanging cap 110.

Accordingly, the sub-cap 115 comprises a flange 117 projected outwardly to be stopped by the step 113, an rounded end 118 of a portion that the sub-cap 115 is exposed outwardly, a hole 116 bored so that the hanging wire 112 can be inserted and stopped, and an inner surface 119 formed inside the sub-cap 115.

And the sub-cap 115 inserted inside the hanging cap 110 is made of different material, i.e., metal, or color with the hanging cap 110, in this case, an aesthetic sense for present invention is obtained, furthermore, in case of assembling the hanging cap 110, the end of the hanging wire 112 is knotted and stopped inside the sub-cap 115 and then the flange 117 of the sub-cap 115 is stopped in the step 113.

And because the hanging rod 130 pushes the sub-cap 115 outwardly, the sub-cap 115 is coupled inside the hanging cap 110 and an aesthetic sense for present invention is obtained.

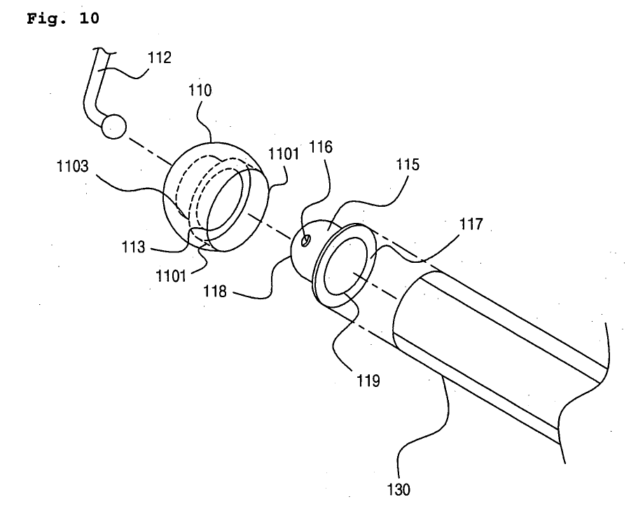

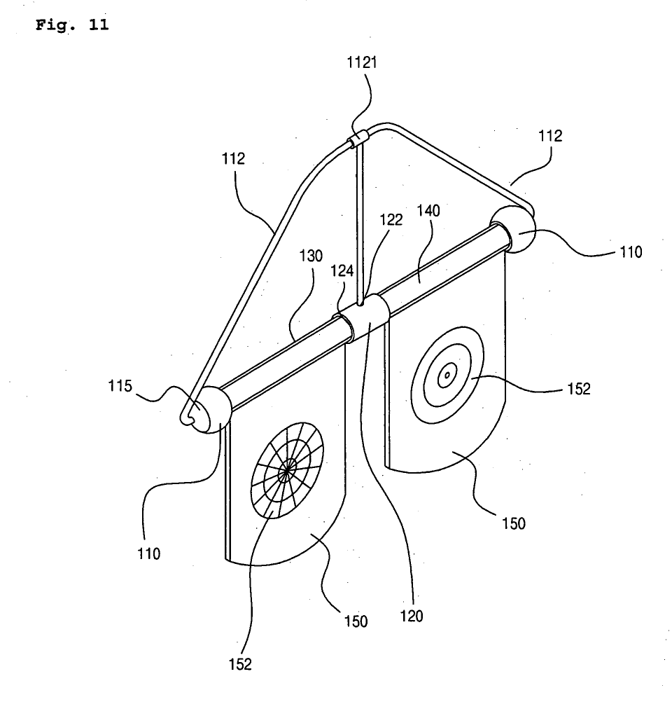

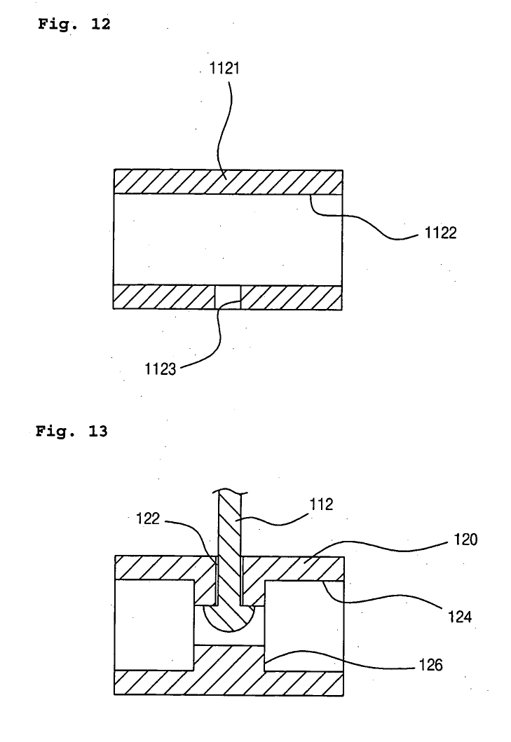

FIGS. 11 to 13 are outer perspective views illustrating a using state and cross-sectional view, its difference with the embodiment described in FIGS. 9 and 10 is that an intermediate coupling piece 120 is formed between the hanging caps 110 so that a plurality of printed hanging sheets 150 can be connected in a horizontal direction and other things are similar with the embodiments described above.

That is, the intermediate coupling piece 120 functioning as a connector for coupling a plurality of printed hanging sheets 150 comprises an end hole 124 bored inside it, a step 126 stepped inwardly so that it prevents both hanging rods 130 from being in contact with each other, and a third coupling hole 122 bored outwardly in the step 126.

The hanging wires 112 can be connected by winding, but desirably it is convenient that the hanging wires 112 are connected by using a coupling piece 1121, and the coupling piece 1121 has a plurality of holes so that the hanging wires 112 can be coupled to each other in various directions, that is, the holes are the first coupling hole 1122 formed in a horizontal direction and the second coupling hole 1123 formed in a vertical direction.

Accordingly, one end of the hanging rod 130 is stopped and supported to the step 113 of the hanging cap 110, and the other end of the hanging rod 130 is stopped and supported to the step 126 of the intermediate coupling piece 120. Therefore a plurality of printed hanging sheets 150 are coupled to each other in a horizontal direction. Because the hanging wire 112 is coupled through the hole 122 formed in the step 126, the drooping by weight of the printed hanging sheet 150 is prevented and the present invention can be used safe.

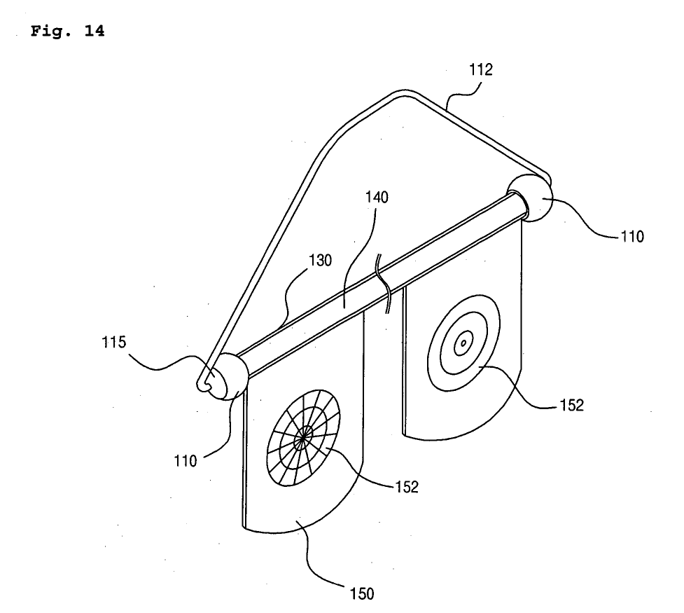

And FIG. 14 is other embodiment of the present invention, the difference with the embodiments described above is that the hanging rod 130 is formed as a single structure and used conveniently without the intermediate coupling piece 120, accordingly a plurality of the printed hanging sheet 150 can be used together.

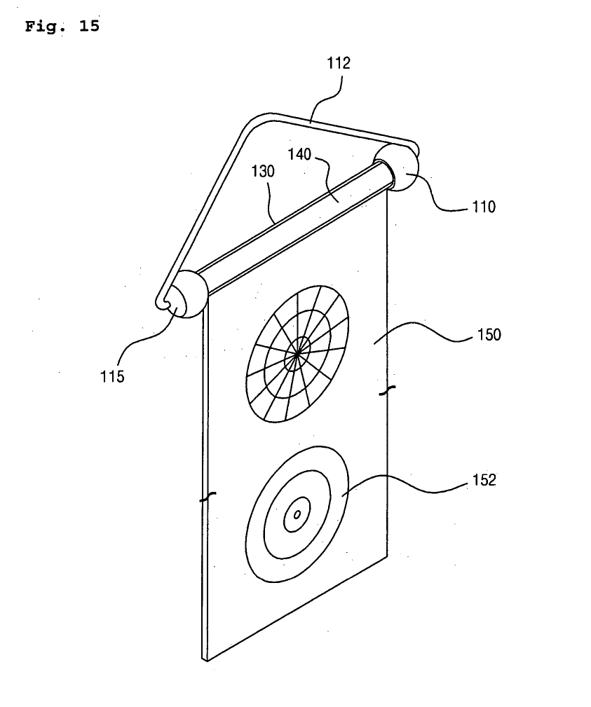

In addition, FIG. 15 is another embodiment of the present invention, the difference with the embodiments described above is that a plurality of games or designs are printed on one printed hanging sheet 150, and other things are similar with the above embodiments.

Accordingly, in case that a plurality of printed parts 152 are formed on one printed hanging sheet 150, the printings for a dart game and a target game can be formed together according to the using state.

In the embodiments described above, it is described that the printed hanging sheet 150 is coupled to two hanging rods 130 in a horizontal direction and a plurality of printings in a vertical direction are formed in the printed hanging sheet 150. But in the present invention, without limitation to the embodiments described above, a plurality of printed hanging sheets 150 are connected to each other and can be used for interior decoration, and the size of it is formed variously according to the user.

And in case that the printed hanging sheet 150 is used for a dart plate for a dart game, the magnetic dart 200 is needed additionally, and to solve this problem, the same applicant already filed a utility model application (application no.: 20-2002-36931, title: structure of a magnetic dart pin for a dart game) before the Korean Intellectual Property Office in accordance with the magnetic dart 200, wherein, the end of the magnetic dart 200 is made of metal and the magnet 210 is inserted inside the metal by pressure, and then a portion of the end of the magnet 210 is exposed outwardly so that the magnetic dart 200 can be attached to the iron-rubber plate 157.

As apparent from the above description, the multipurpose hanging picture according to the present invention provides advantages in that, a plurality of hanging pictures are consecutively connected to each other and pictures, paintings and dart games are provided, and because the hanging picture on which a dart game is printed can be folded and carried, user can enjoy the dart game everywhere, and user can conveniently keep articles in the lower side of the hanging picture.

Furthermore, the present invention provides advantages in that, the advertisement unit is formed on one side or both sides of the hanging rod connecting the hanging pictures or the dart plates and the advertisement function is very effective, in particular, because the a plurality of hanging pictures can be connected in vertical or horizontal direction and used, it can be used for event or interior decoration in addition to the function as the multipurpose hanging picture.

What is claimed is:

1. A multipurpose hanging picture comprising:
a printed hanging sheet on which pictures, paintings, targets or dart games are printed;
a hanging rod detachably coupled to one side or both sides of the printed hanging sheet;
an advertisement unit mounted to the hanging rod and functioning as an advertisement;
a hanging cap mounted to both ends of the hanging rod and supporting it; and
a hanging wire coupled to the hanging caps and stopped by it.

2. The multipurpose hanging picture as set forth in claim 1, wherein said hanging rod comprises at lease one locking slit provided on an outer surface of the hanging rod, a reinforcing rib formed inside the hanging rod to support it, and at least one locking groove provided concavely on the outer surface of the hanging rod so that the advertisement unit can be detachably attached.

3. The multipurpose hanging picture as set forth in claim 1, wherein said advertisement unit further comprises a thermometer in the shape of plane.

4. The multipurpose hanging picture as set forth in claim 1, wherein said printed hanging sheet comprises an iron-rubber plate made of an iron-rubber sheet so that a magnet formed at the end of a magnetic dart may be attached to it, an outer sheet mounted to an outer surface of the iron-rubber plate and on which a printed part for a dart game is formed, and an adhesive spread between the iron-rubber plate and the outer sheet and bonding them together not to be separated.

5. The multipurpose hanging picture as set forth in claim 1, wherein said printed hanging sheet further comprises a pocket formed detachably at a lower end of it by use of snap fasteners according to user's preference and keeping articles.

6. The multipurpose hanging picture as set forth in claim 1, wherein said printed hanging sheet is made of paper, textile, leather, plastic, iron plate or iron-rubber sheet.

7. The multipurpose hanging picture as set forth in claim 1, wherein said hanging cap comprises a step stepped inside the hanging cap and a sub-cap, in which a flange is provided to be stopped by the step.

8. The multipurpose hanging picture as set forth in claim 1, wherein an intermediate coupling piece is mounted additionally between the hanging rods so that a plurality of printed hanging sheets coupled to the hanging rod can be connected to each other in a horizontal direction.

9. The multipurpose hanging picture as set forth in claim 1, wherein said hanging rod is consecutively coupled to an upper and lower side of the printed hanging sheets so that a plurality of printed hanging sheets coupled to the hanging rod can be connected to each other in a vertical direction.
